(19) United States
(12) Patent Application Publication
(10) Pub. No.: US 2026/0133421 A1
(43) Pub. Date: May 14, 2026

(54) DISPLAY DEVICE HAVING INTERFERING LIGHT SUPPRESSION

(71) Applicant: Continental Automotive Technologies GmbH, Hannover (DE)

(72) Inventors: Hans-Peter KREIPE, Dieburg (DE); Kai HABERMEHL, Ober-Ramstad (DE)

(21) Appl. No.: 19/384,493

(22) Filed: Nov. 10, 2025

(30) Foreign Application Priority Data
Nov. 11, 2024 (DE) 10 2024 210 820.0

(51) Int. Cl. G02B 27/01

(52) U.S. Cl. CPC G02B 27/0101; G02B 2027/0118

(57) ABSTRACT

A display device having interfering light suppression. The display device has a display panel and a transparent element arranged on a top side of the display panel. The material of the transparent element is selected such that there is no refractive index jump at the transition from the display panel to the transparent element. The transparent element has a curved top side designed to deflect incident interfering light in the direction of a light trap.

### BACKGROUND OF THE INVENTION

### 1. Field of the Invention

The present disclosure relates to a display device having interfering light suppression.

### 2. Description of Related Art

The number and area of display devices in a transport are constantly increasing. For example, display devices can be found on the market as an instrument cluster for the driver, as a central display, and also as a front passenger display.

Head-up displays are also increasingly found in a transport. A head-up display, also referred to as HUD, is understood to mean a display system in which the viewer can maintain their viewing direction since the contents to be presented are inserted into their field of view. While such systems were originally used primarily in the aerospace sector due to their complexity and costs, they are now also being installed in large-scale production in the automotive sector.

Head-up displays generally consist of a picture generating unit (PGU), an optical unit, and a mirror unit. The picture generating unit produces the image and for this purpose uses at least one display element. Most head-up displays nowadays use LCD-based displays (LCD: liquid crystal display). The optical unit directs the image onto the mirror unit. The mirror unit is a partially reflecting, light-transmissive pane. The viewer thus sees the contents presented by the picture generating unit as a virtual image and sees the real world behind the pane at the same time. In the automotive sector, the windshield is often used as a mirror unit, and the curved shape of the windshield must be taken into account in the presentation. Due to the interaction between the optical unit and the mirror unit, the virtual image is an enlarged presentation of the image produced by the picture generating unit.

In one aspect, displays are arranged relative to the windshield such that these displays can be viewed across the windshield and the virtual depth is provided directly with the distance to the windshield. Such displays are referred to as scenic-view displays. At present, the image contents of the scenic view displays are mirrored via a black-tinted region of the windshield in order to avoid direct incidence of sunlight or light from other light sources onto the display. Without this black-tinted region in the windshield, the sunlight or extraneous light can reach the display directly and be overlaid with the image content as a back-reflection or backscattering. This may result in the driver becoming distracted or disturbed, which must be avoided at all costs.

In this context, DE 10 2010 032 998 A1 describes a head-up display for a motor vehicle, having a projection apparatus by which an image to be displayed is projected onto a windscreen of the motor vehicle, which windscreen acts as a combining apparatus. The projection apparatus has a semi-transparent cover directed toward the windscreen which is designed to reflect extraneous light that is incident on the cover from outside onto an absorber surface. The absorber surface is formed at least partially by an internal coating of the windscreen.

WO 2019/238849 A1 describes an apparatus for generating a virtual image having interfering light suppression. The apparatus has a light source, a display element for producing an image, and an anti-glare element. The anti-glare element has a curved surface.

### SUMMARY OF THE INVENTION

It is an object of one aspect of the invention to provide an improved display device having interfering light suppression.

According to a first aspect of the invention, a display device has a display panel and a transparent element arranged on a top side of the display panel. The material of the transparent element is selected such that there is no refractive index jump at the transition from the display panel to the transparent element. The transparent element has a curved top side designed to deflect incident interfering light in the direction of a light trap.

In the solution according to one aspect of the invention, the display panel is placed under a cover, the surface of which is curved such that there is a matching deflection of the incident light. In this case, the surface satisfies the requirements of a geometric anti-reflective coating. In addition, the material of the cover is selected such that there is no index jump from the outer surface to the display panel. To this end, the cover is shaped such that the space between the display panel and the curved surface is fully filled with the material of the cover. In this way, interfering back reflections are avoided. For example, the display device may be installed in a shaft such that incident interfering light is directed into a shaft wall acting as a light trap.

According to one aspect of the invention, the display panel has a planar design. In this way, a commercially available display panel can be used to realize the display device, which is advantageous in terms of production costs.

According to one aspect of the invention, the display panel is arranged obliquely relative to a viewing direction. This allows the curvature of the transparent element to be conveyed across the surface of the display panel. In this way, less material is required for producing the transparent element, which is advantageous in terms of the material costs and the weight of the overall system.

According to one aspect of the invention, the display panel has a curved design. In this embodiment, a specially shaped display panel is required. By contrast, however, the transparent element may have a very thin design resulting in a reduced weight of the overall system.

According to one aspect of the invention, the display device has a transparent pane designed to reflect an image displayed by the display panel in the direction of a viewer. The use of a transparent pane, such as the windshield of a motor vehicle, allows for a scenic-view display to be realized.

According to one aspect of the invention, the transparent pane has a blackened region. Some image components of the display region of the display panel are then reflected via the blackened region of the pane, while other image components are reflected via the transparent region of the pane. The placement of the light trap may be selected individually in accordance with the desired implementation of the overall system.

According to one aspect of the invention, the display device has a backlighting designed such that light emitted by the backlighting illuminates the head position of one or more viewers. For example, the light for backlighting the display panel may be shaped so as to illuminate the head position of a driver of a motor vehicle or to illuminate a narrow cone of light from the head position of the driver to the head position of a front passenger.

According to one aspect of the invention, the light trap is designed as a light-absorbing wall. In this way, it can be ensured that no interfering light reflections emanate from the light trap.

According to one aspect of the invention, the display device, on its own or in combination with further display devices, forms a display strip. In the case of such a display strip, the width of the common display region is significantly greater than the height of the display region. For example, the design as a display strip allows for a display to be realized that extends over the entire width or at least almost the entire width of a dashboard of a motor vehicle.

According to one aspect of the invention, a light shaping in the display strip is implemented such that, for at least a part of the display strip, image contents are permanently and/or switchably visible only for one of a plurality of viewer positions. For example, the light shaping may be implemented such that certain image contents are visible only to the driver or only to the front passenger of a motor vehicle. On the one hand, this may be the case permanently, but it is also possible for the visibility of the image contents to be switched individually if necessary. In addition, it is possible to switch between an operating mode with an unrestricted public mode and an operating mode with privacy mode via the light shaping, i.e., the overall system may be designed as a switchable privacy display.

A display device according to the invention is preferably used in a transport. For example, the transport may be a motor vehicle, but may alternatively be also an aircraft, a rail vehicle, or a water vehicle. Using the solution according to the invention is possible here, in particular, for all display and head-up display systems in which interfering light suppression is necessary or desirable. Furthermore, however, a display device according to the invention may also be used for cinemas, displays close to the eye, or multimedia applications in general.

Further features of the present invention will be apparent from the following description and the appended claims in conjunction with the figures.

### BRIEF DESCRIPTION OF THE DRAWINGS

FIG. 1 is a schematic diagram of a display device according to the invention;

FIG. 2 is a schematic diagram of a display device according to the invention;

FIG. 3 is a schematic diagram of a display device according to the invention;

FIG. 4 is a schematic diagram of a display device according to the invention;

FIG. 5 is a schematic diagram of a backlighting;

FIG. 6 is a schematic diagram of a backlighting; and

FIG. 7 is a schematic diagram of a transport utilizing a display device according to the invention.

### DETAILED DESCRIPTION OF THE PRESENTLY PREFERRED EMBODIMENTS

For better understanding of the principles of the present invention, aspects of the invention will be explained in the following in more detail with reference to the figures. Identical reference numerals are used for identical or functionally identical elements in the figures and are not necessarily described again for each figure. It is understood that the invention is not limited to the presented embodiments and that the described features may also be combined or modified without departing from the scope of protection of the invention as defined in the appended claims.

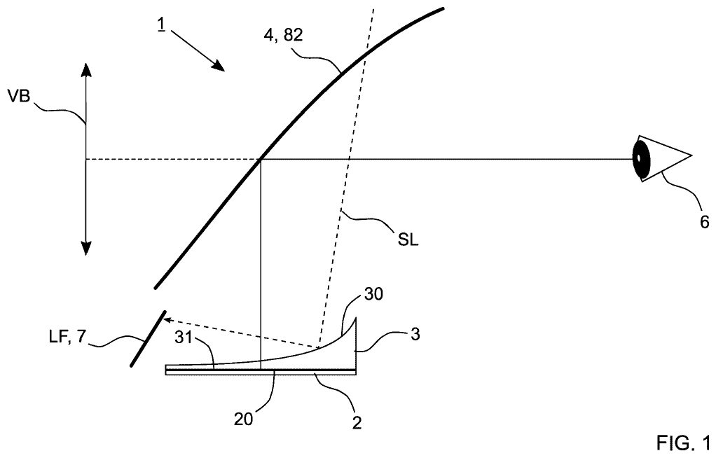

FIG. 1 shows a schematic diagram of a display device 1 according to an aspect of the invention. The display device 1 has a display panel 2 and a transparent element 3 arranged on a top side 20 of the display panel 2. The transparent element 3 has a curved top side 30 designed to deflect incident interfering light IL in the direction of a light trap LT. For example, the light trap LT may be formed by a light-absorbing wall 7 of a shaft in which the display device 1 or the display panel 2 and the transparent element 3 are installed. Instead of such a shaft, only the light-absorbing wall 7 is shown in FIG. 1.

The material of the transparent element 3 is selected such that there is no refractive index jump at the transition from the display panel 2 to the transparent element 3. To this end, the transparent element 3 is shaped such that its bottom side 31 rests on the top side 20 of the display panel 2, and thus the space between the display panel 2 and the curved top side 30 is fully filled with the material of the transparent element 3. The light L emitted by the display panel 2 is reflected in the direction of a viewer 6 via a transparent pane 4, here the windshield 82 of a motor vehicle. The viewer 6 sees a virtual image VI, the virtual depth of which is provided by the distance of the display panel 2 from the windshield 82.

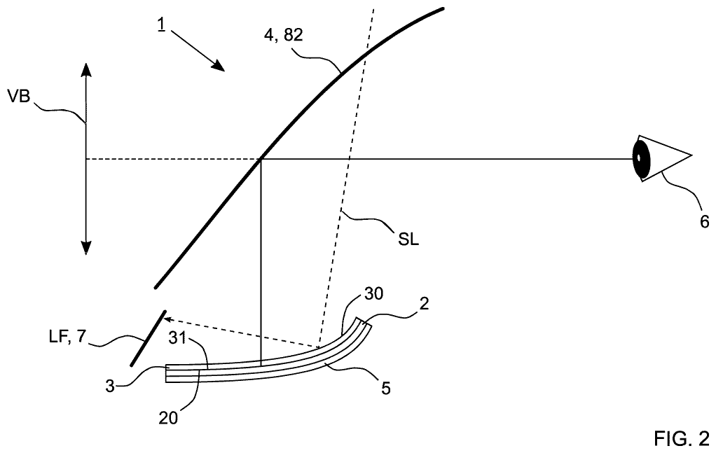

FIG. 2 shows a schematic diagram of a display device 1 according to an aspect of the invention. In this aspect, the display device 1 has a curved display panel 2 and a curved backlighting 5 adapted thereto. Due to the curvature of the display panel 2, the transparent element 3 may have a very thin design. This results in a reduced weight of the overall system.

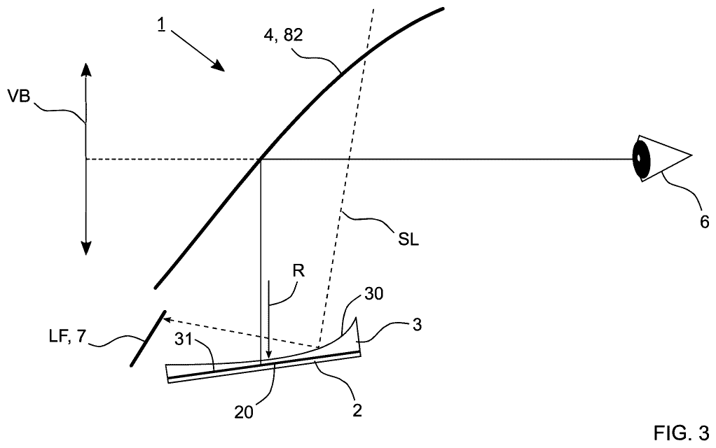

FIG. 3 shows a schematic diagram of a display device 1 according to one aspect of the invention. The exemplary embodiment substantially corresponds to the exemplary embodiment of FIG. 1, but a planar display panel 2 is installed, which is arranged obliquely relative to a viewing direction D. This allows the curvature of the transparent element 3 to be conveyed across the surface of the display panel 2. In this way, less material is required for producing the transparent element 3, which is advantageous in terms of the material costs and the weight of the overall system.

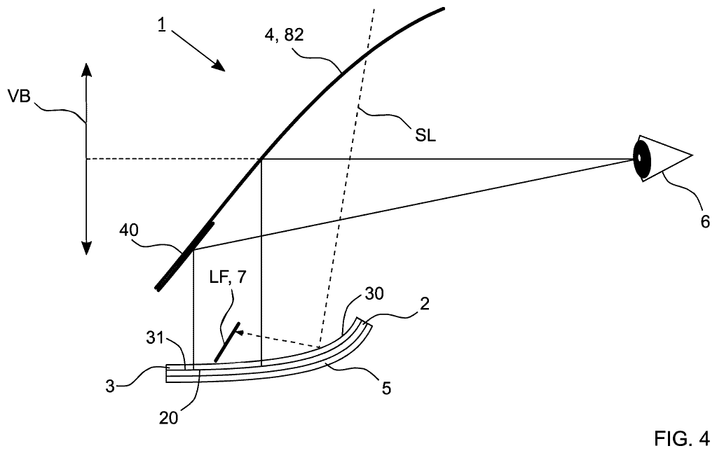

FIG. 4 shows a schematic diagram of a display device 1 according to one aspect of the invention. The exemplary embodiment substantially corresponds to FIG. 2, but the transparent pane 4, here the windshield 82, has a blackened region 40. Some image components of the display region of the display panel 2 are then reflected via the blackened region 40 of the pane 4, while other image components are reflected via the transparent region of the pane 4. The placement of the light trap LT may be selected individually in accordance with the desired implementation of the overall system.

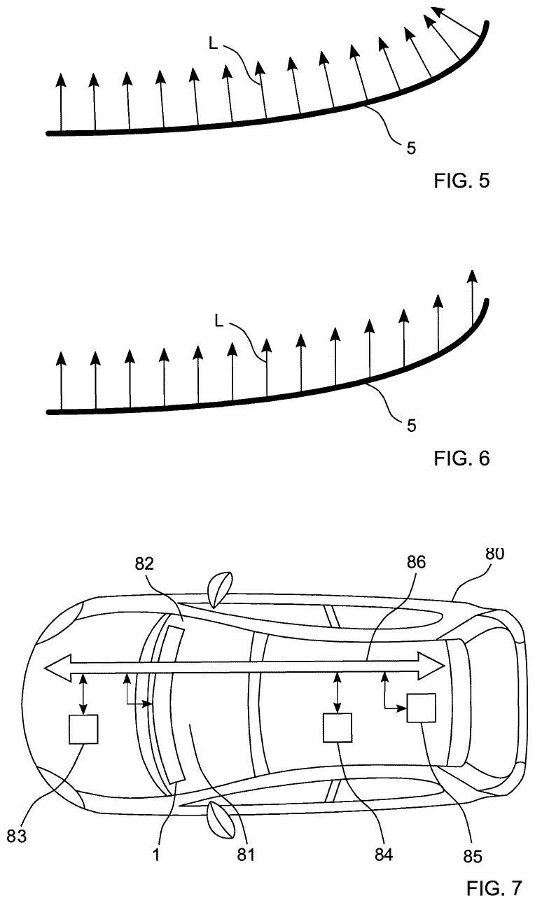

FIG. 5 shows a schematic diagram of a backlighting 5. The backlighting illustrated by the arrows is perpendicular to the surface of the display panel. A second backlighting 5 is shown schematically in FIG. 6. In this aspect, the backlighting illustrated by the arrows is parallel to the viewing direction. In this case, the display panel may be arranged perpendicularly or alternatively obliquely relative to the viewing direction. The light shaping by the backlighting 5 allows for light L emitted by the backlighting 5 to illuminate the head position of one or more viewers. For example, the light L for backlighting the display panel may be shaped so as to illuminate the head position of a driver of a motor vehicle or to illuminate a narrow cone of light from the head position of the driver to the head position of a front passenger.

FIG. 7 shows a schematic diagram of a transport 80 utilizing a display device 1. In this example, the transport 80 is a motor vehicle. The motor vehicle has a display device 1, in the example presented in the form of a scenic view display, which is arranged in a dashboard 81 below the windshield 82. The display device 1 may be utilized to display instructions from a navigation system 83, for example. A data transfer unit 84 may be used to set up a connection to a backend, for example to obtain updated software for components of the motor vehicle. A memory 85 is present for storing data. Data is exchanged between the various components of the motor vehicle via a network 86.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A display device having:
a display panel; and
transparent element arranged on a top side of the display panel;
wherein a material of the transparent element is chosen such that there is no refractive index jump at a transition from the display panel to the transparent element, and
wherein the transparent element has a curved top side designed to deflect incident interfering light in a direction of a light trap.

2. The display device according to claim 1, wherein the display panel has a planar design.

3. The display device according to claim 2, wherein the display panel is arranged obliquely relative to a viewing direction.

4. The display device according to claim 1, wherein the display panel has a curved design.

5. The display device according to claim 1, further comprising:
a transparent pane configured to reflect an image displayed by the display panel in a direction of a viewer.

6. The display device according to claim 5, wherein the transparent pane has a blackened region.

7. The display device according to claim 1, further comprising:
a backlighting configured such that light emitted by the backlighting illuminates a head position of one or more viewers.

8. The display device according to claim 1, wherein the light trap is a light-absorbing wall.

9. The display device according to claim 1, wherein the display device on its own or in combination with further display devices forms a display strip.

10. The display device according to claim 9, wherein a light shaping in the display strip is implemented such that, for at least a part of the display strip, image contents are permanently and/or switchably visible only for one of a plurality of viewer positions.
